(19) United States
(12) Patent Application Publication
(10) Pub. No.: US 2007/0019550 A1
(43) Pub. Date: Jan. 25, 2007

(54) Shaper control method, data communication system, network interface apparatus, and network delay apparatus

(75) Inventor: Tadashi Enomoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Communication Systems, Ltd.

(21) Appl. No.: 11/358,120

(22) Filed: Feb. 22, 2006

(30) Foreign Application Priority Data
Jun. 29, 2005 (JP) 2005-190273

(51) Int. Cl. H04L 12/26

(52) U.S. Cl. 370/235

(57) ABSTRACT

Upon controlling the operation of a shaper for performing the shaping of data communication that establishes a flow between data communication apparatuses via a network, the data communication apparatus identifies the flow and designates whether or not the shaping of the identified flow is performed, and the shaping on the unit basis of the flow is performed in accordance with the designation.

This application claims priority to prior Japanese patent application JP 2005-190273, the disclosure of which is incorporated herein by reference.

### BACKGROUND OF THE INVENTION

1. Field of the Invention

The present invention relates to shaping on a data communication network. More particularly, the present invention relates to the control of shaping.

2. Description of the Related Art

In the transfer of a large amount of data via a data communication network (hereinafter, simply referred to as a network), such as the Internet, a transmission data packet (hereinafter, referred to as data or a data packet) from the transmission side is measured with high time resolution, and a time zone for transmitting data packet in burst at a short time interval and a time zone without transmitting data are alternately repeated in many cases. Hereinbelow, the traffic with the repetition of the burst transmission and the interrupt is referred to as an ON/OFF traffic.

Shaping is a technology for smoothing the variation of transfer velocity. Patent Document 1 (Japanese Unexamined Patent Application Publication No. 2001-244990) discloses traffic management system for both peak-rate shaping and average-band ensuring in the connection of many users by combining peak-rate shaper and WFQ scheduler.

Further, Patent Document 2 (Japanese Unexamined Patent Application Publication No. 2003-198611) discloses a traffic shaper for ensuring the minimum safe band of the traffic and transferring a variable-length packet with a free band of a communication line.

In Patent Documents 1 and 2, the traffics are used in a lump on the unit basis of user in consideration of the management of a network service provider or a network.

With the above conventional arts, the shaping is performed on the unit basis of a user or a data communication apparatus. Therefore, a plurality of flows are established in the same user and the same data communication apparatus. In one of the flows, congestion is caused, thereby impacting another flow.

In one packet of ON/OFF traffic, the congestion for a short time is caused at the bottle neck on the network and is abandoned. Further, the packet in another flow packet passing through the same bottle neck is abandoned in many cases. As a consequence thereof, the communication quality of the flow deteriorates and the communication quality of the other flow passing through the same bottle neck also deteriorates. Furthermore, in a protocol for re-transmitting the packet upon abandoning the packet like a TCP (Transmission Control Protocol), the number of re-transmitted packets increases, thereby deteriorating the using efficiency of a resource of the network, i.e., processing a capacity of a communication band and a router.

The ON/OFF traffic is caused in the transmission data packet of the TCP protocol because of a flow control system of the TCP protocol, that is, slow start. At the slow start, the size of transmission window increases 1, 2, 4, . . . in accordance with reception of a transmission check packet (hereinafter, referred to as ACK or ACK packet). That is, a lump of data packet larger than that of the previous response is transmitted every reception of the ACK packet. FIG. 15A schematically showing the chance for increasing the size of transmission window in a TCP-Ren-oversion TCP. Referring to FIG. 15A, the data packet becomes a lump so as to increase the size of transmission window when the ACK packet reaches.

On the hand, even in a UDP protocol without checking the transmission, the ON/OFF traffic can be caused. Depending on the type of OS, it is determined whether or not an application program for transmitting a moving image with the UDP protocol can control the transmission period of the data packet. FIGS. 15A and 15B are plot diagrams showing average transmission-rates are plotted every 10 packets on two types of OS-A and OS-B execute an application program for transferring the image with the UDP protocol. Referring to FIG. 15A, on the OS-A, such operation is repeated that the image is transmitted for 10 ms at a rate approximate to 100 Mbps, thereafter, the operation is paused for 25 ms, and the image is transmitted again for 10 ms at a rate approximate to 100 Mbps. On the other hand, referring to FIG. 15B, on the OS-B, the image is relatively stably transmitted at a rate approximate to 30 Mbps.

The ON/OFF traffic is caused on the OS-A because the basic period for starting an OS-A scheduler is longer than the transmission period of the data packet. The output at a constant transmission rate needs the transmission of the data packet at a time interval shorter than the basic period for starting the scheduler of the OS that is currently widely used. For example, the data packet needs to be transmitted at the time interval of approximately 270 msec so that a data packet with 1024 bytes is transmitted at the same time interval with the transmission rate of 30 Mbps. On the OS that is generally widely sued, the basic period is 10 msec, and a transmission program cannot start with accuracy for a period of one msec or less.

Further, on an application program for transferring and displaying a moving image in realtime with a protocol for re-transmitting the data packet in accordance with the abandonment of the data packet like TCP, burst traffic for supplement of abandoned data packet is caused and the data packet is transmitted in burst. Such the vicious spiral that the burst transmission causes the abandonment of next data packet generates a phenomenon of a long recovery time of stable operation. This is caused by the following reason.

In the application program for transferring and displaying the moving image with the TCP protocol, the application program on the reception side has a large number of buffers, thereby absorbing the delay of temporary reach data due to the abandonment of the data packet.

The data packet is abandoned on the TCP protocol on the reception side and, in this case, reception data cannot be transmitted to application until the reach timing of the data packet re-transmitted. On the side of the application program, the reach of data is interrupted. The application program is a realtime one and, therefore, the amount of data in the buffer of the application program reduces in accordance with the time passage. On the application program on the reception side, the reduction of the amount of data in the buffer is detected and, subsequently, the data is read at the highest velocity via the TCP protocol so as to recover the amount of data in the buffer. On the TCP protocol, the data packet reaches after receiving the re-transmitted data and, subsequently, the ACK packet for always waiting the next data packet is returned. On the TCP program on the transmission side that receives the ACK packet for waiting the next data packet, the data packet is to be sequentially transmitted, thereby increasing the peak rate. The increase in peak rate further causes the abandonment of the data packet.

Note that the amount of reception buffer is set to a header portion of the ACK packet. When the application does not receive the reception data, the TCP protocol reduces the amount of reception buffer to be returned at the header portion of the ACK packet and further suppresses the data transmission on the transmission side. Herein, the ACK packet for waiting the data packet means a large amount of reception buffer that does not suppress the data transmission on the transmission side. When the data packet stably flows, the application mixedly returns the ACK packet that suppresses the data transmission on the transmission side and the ACK packet that waits the data packet.

Further, according to another conventional art, a network relay apparatus performs the shaping on the unit basis of data flow. In the above-mentioned network relay apparatus, a network administrator can set the shaping on the unit basis of data flow. However, the shaping cannot be properly set in accordance with the continuously changing situation. Because this operation is based on the update of a fixed value every data flow in the network relay apparatus and the dynamic change of setting is not considered.

### SUMMARY OF THE INVENTION

As mentioned above, the ON/OFF traffic is caused by the change of the amount of transmission data in accordance with the time passage due to the flow control system and a starting period of the scheduler of the OS.

The present invention is devised in consideration of the above-mentioned situation. It is one object of the present invention to provide a technology for controlling the shaping on the unit basis of data flow in accordance with the change of a computer program and a network that establish the data flow in accordance with the time passage.

Further, it is another object of the present invention to provide a technology for smoothing, on the unit basis of data flow, the change of the amount of transfer data due to the flow control system.

Furthermore, it is another object of the present invention to provide a technology for solving the above problems irrespective of the type of OS.

In order to solve the above problems, the present invention provides the following technologies.

According to the present invention, there is provided a method of controlling a shaper for traffic shaping to flows of data communication between first and second data communication apparatuses, the method comprising: a step of identifying a flow by the first data communication apparatus; a step of designating, by the first data communication apparatus, whether or not the shaping to the identified flow is performed; and a step of performing the shaping on the unit basis of a flow by the shaper in accordance with the designation.

Preferably, the first data communication apparatus designates shaping setting information on the unit basis of a flow, the shaping setting information being setting information for traffic shaping by the shaper. The shaping setting information on a flow may be updated in accordance with condition of the flow.

Best-effort-type communication may be provided for a flow to which performance of the shaping is not designated at the designating step.

Further, according to the present invention, there is provided a data communication system comprising: a circuit for designating, on the unit basis of a flow, whether or not the shaping of a flow between one data communication apparatus and another data communication apparatus is performed; and a shaper for performing the shaping on the unit basis of the flow in accordance with the designation.

The data communication system may further comprise a circuit for designating, on the unit basis of a flow, shaping setting information, serving as setting information on the shaping, and the shaper performs the shaping in accordance with the shaping setting information.

The data communication system may further comprise a circuit for estimating the condition of the flow, wherein the shaping setting information of the flow is updated in accordance with the estimation result.

Best-effort-type communication may be provided for the flow to which the shaping is not designated by the circuit for designating whether or not the shaping is performed.

Further, according to the present invention, there is provided a network interface apparatus for providing a network interface apparatus for providing a network interface for a computer by being connected to the computer via a control interface and a data transfer interface of the computer, comprising a shaper for performing shaping on the unit basis of a flow.

Preferably, the shaper may perform shaping of a flow designated by the computer or by another computer establishing the flow with the computer for data communication.

Shaping of the shaper may be set in accordance with the setting information that is generated by the computer or by another computer establishing the flow with the computer for data communication.

The setting of the shaper may be updated in accordance with condition of the flow received by the computer or by another computer establishing the flow with the computer for data communication.

Further, the network interface apparatus may comprise a circuit for extracting control information of the shaper from a packet which stores control information of the network interface apparatus. Thus, it is possible to receive the control information based on the packet via a data transfer interface.

The network interface apparatus may provide best-effort-type communication to a flow without the designation.

Further, according to the present invention, there is provided a network relay apparatus comprising a shaper for shaping on the unit basis of a flow through the network relay apparatus, wherein the shaper performs shaping of a flow in response to a request from a data communication apparatus establishing the flow.

The shaping may be set in accordance with setting information generated by the data communication apparatus.

The shaping may be set in accordance with the condition of the flow obtained by the data communication apparatus.

Further, according to the present invention, there is provided a computer program product for a computer system performing data communication with a data communication apparatus by establishing a flow with the data communication apparatus, a shaper performing shaping of the flow, wherein the computer program product comprises one or more computer-readable media having computer-executable instructions for performing the steps of: generating flow identification for identifying a flow; generating a flag for designating whether or not the shaper performs shaping of the flow; and outputting the flow identification information and the flag so that the shaper performs the shaping in accordance with the flow identification information and the flag.

Further, the media may further have computer-executable instructions for performing the steps of generating shaping setting information, serving as setting information on the shaping of the flow.

Furthermore, the media may further have computer-executable instructions for performing the steps of: estimating the communication of the flow; and generating the shaping setting information in accordance with the estimating result.

The following advantages according to the present invention are obtained.

As a first advantage, the communication quality is improved. In the smoothed traffic, the number of abandoning times of the packet is reduced because a transmission buffer overflows at the bottle neck in the network, as compared with a burst traffic. In particular, a function for dynamically changing the band of the shaper is shared, thereby increasing the advantage of the system for changing a transmission rate in accordance with the network. Moving-image distribution application has a function for changing a transmission rate in accordance with the network. However, a transmission output has an ON/OFF traffic, the band of the shaper is fixed and, in this case, a peak rate has the ON/OFF traffic, serving as the setting band of the shaper. The advantage for changing the transmission rate in accordance with the network is suppressed. The burst characteristic can be improved and the number of abandoned packets can be reduced by dynamically changing the band of the shaper to an average transmission rate of the application.

As a second advantage, the use efficiency of a network resource is improved. The number of abandoning times of the smoothed traffic in the network is reduced, as compared with the burst traffic. Corresponding to this, the number of abandoning times of the packet for connection to another communication device is reduced. Therefore, first, an unnecessary network resource for carrying the packet to be abandoned to the abandoning place is not used. Secondly, a rate of the re-transmission packet of all users of the network is reduced and, therefore, the number of re-transmitting times of the packets arrived to the reception side is reduced. Only the re-transmission of the abandoned data packet is within the first reason. However, on a TCP protocol, the re-transmission packet is abandoned, the time is out for a standby mode of an ACK, and the packet arrived to the reception side is also re-transmitted. Therefore, the transfer efficiency is further reduced as well as the first efficiency-reduction.

### BRIEF DESCRIPTION OF THE DRAWINGS

FIG. 1 is a functional block diagram showing a data communication apparatus according to the first embodiment of the present invention;

FIG. 2 is an explanatory diagram of the data structure of initial setting data and dynamic setting data;

FIG. 3 is an explanatory diagram of the structure of flow identification information;

FIG. 4 is an explanatory diagram of the structure of data stored in a flow-registering-data storing unit;

FIG. 5 is a functional block diagram showing a data communication apparatus according to the second embodiment of the present invention;

FIG. 6 is a functional block diagram showing a data communication apparatus according to the third embodiment of the present invention;

FIG. 7 is a functional block diagram showing a data communication apparatus according to the fourth embodiment of the present invention;

FIG. 8 is a functional block diagram showing a network relay apparatus, as a part of the fourth embodiment of the present invention;

FIG. 9 is an explanatory diagram of a traffic pattern on an application program for transmitting data at a transfer velocity of 30 Mbps with a network interface apparatus without having a shaper function;

FIG. 10 is an explanatory diagram of a traffic pattern on an application program for transmitting data at a transfer velocity of 10 Mbps with the network interface apparatus without having the shaper function;

FIG. 11 is an explanatory diagram of a traffic pattern on an application program for transmitting data of 30 Mbps with the data communication apparatus when a shaper band is fixed to 30 Mbps according to the present invention;

FIG. 12 is an explanatory diagram of a traffic pattern on an application program for transmitting data of 10 Mbps with the data communication apparatus when a shaper band is fixed to 30 Mbps according to the present invention;

FIG. 13 is an explanatory diagram of a traffic pattern on an application program for transmitting data of 30 Mbps with the data communication apparatus when a shaper band is fixed to 10 Mbps according to the present invention;

FIG. 14 is an explanatory diagram of the change with the time passage of the amount of transmission buffer on a TCP protocol upon properly setting a shaper band and a buffer capacity to the data communication apparatus according to the present invention;

FIGS. 15A and 15B are explanatory diagram of a flow control system for increasing the size of a transmission window from the reception timing of a transmission confirming packet on a TCP protocol, in which a packet becomes a lump; and

FIG. 16 is an explanatory diagram of the occurrence of an ON/OFF traffic depending on the difference of OS in a flow transmitted from the same application program using a UDP protocol.

### DESCRIPTION OF THE PREFERRED EMBODIMENTS

1. First Embodiment

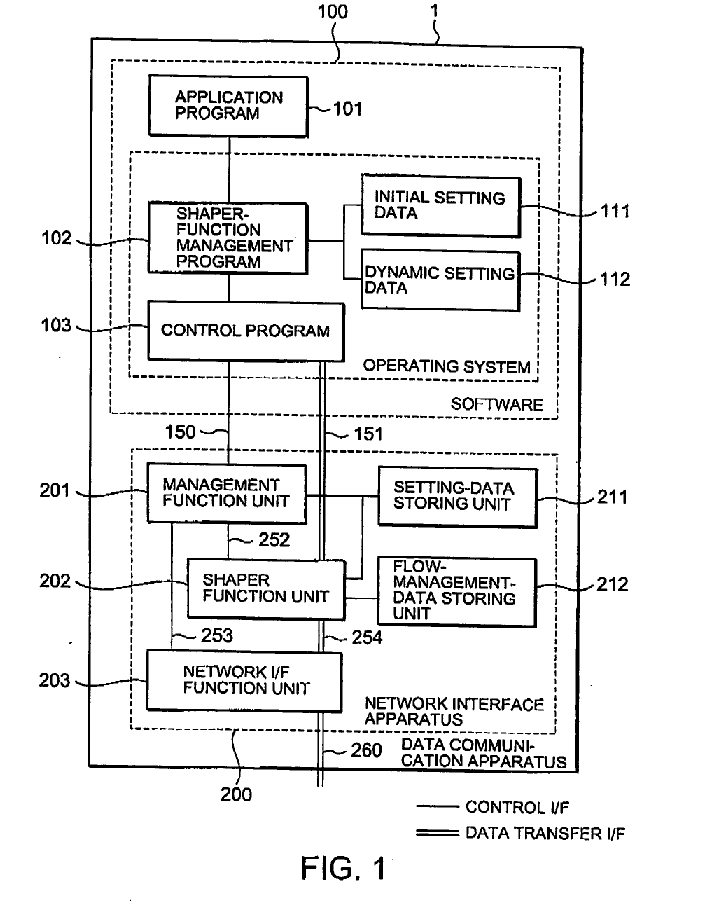

Hereinbelow, a description is given of the structure of a data communication apparatus 1 according to the first embodiment of the present invention with reference to FIG. 1. The data communication apparatus 1, such as a personal computer, a work station, or a server device comprises software 100 that is executed by a processor thereof (not shown), and a network interface apparatus 200 that is an NIC (Network Interface Card) for connecting the data communication apparatus 1 to a network, e.g., a LAN (Local Area Network), a WAN (Wide Area Network), or the Internet.

The software 100 comprises an application program 101, a shaper-function management program 102, and a control program 103, and further comprises initial setting data 111 and dynamic setting data 112. The programs and data are stored to the data communication apparatus 1 or to a memory device (not shown) that is externally arranged, and are read to the processor if necessary.

The application program 101 communicates data with a network via the network interface apparatus 200. When the data communication apparatus 1 is a client computer, the application program 101 is a browser or mailer. When the data communication apparatus 1 is a server computer, the application program 101 includes various programs of a web server, an FTP server, and a streaming server.

Alternatively, the application program 101 may control a shaper function unit 202 in accordance with an instruction of another data communication apparatus connected to the data communication apparatus 1 via the network. Herein, the other data communication apparatus is used by, e.g., a network manager or a manager of the data communication apparatus 1.

The application program 101 generates flow identification information for communicating data with another data communication apparatus. Upon requesting the flow establishment from the application program 101 to the other data communication apparatus, the application program 101 generates the flow identification information before establishing the flow. On the other hand, upon requesting the flow establishment from the other data communication apparatus, the application program 101 may generate the flow identification information before/after establishing the flow. Upon generating or reducing the flow, alternatively upon changing the flow characteristic, the application program 101 designates whether or not the shaping of the flow is performed, with a transmission valid flag or a reception valid flag. The transmission valid flag designates whether or not the shaping of the flow in the external direction from the application program 101 is performed. The reception valid flag designates whether or not the shaping of the flow toward to the application program 101 from the outside is performed. Further, upon designating that the shaping of the flow is performed, a shaper band and a shaper buffer capacity are designated. The generated flow identification information and the generated valid flag are notified to the shaper-function management program 102.

The shaper-function management program 102 controls the network interface apparatus 200 via the control program 103. Specifically, the shaper-function management program 102 controls the initial setting operation of the shaping by the network interface apparatus 200 and the dynamic changing operation of the setting of the shaper function in response to a request from the application program 101 in accordance with the flow identification information and the valid flag from the application program 101. The shaper-function management program 102 reads and writes the initial setting data 111, thereby controlling the initial setting of the shaper function. The shaper-function management program 102 reads and writes the dynamic setting data 112, thereby controlling the dynamic changing operation of the setting of the shaper function.

The control program 103 corresponds to a driver program in the network interface apparatus 200, and controls a network interface function unit 203 via a management function unit 201. Further, the control program 103 transmits the request from the shaper-function management program 102 to the management function unit 201 or the shaper function unit 202.

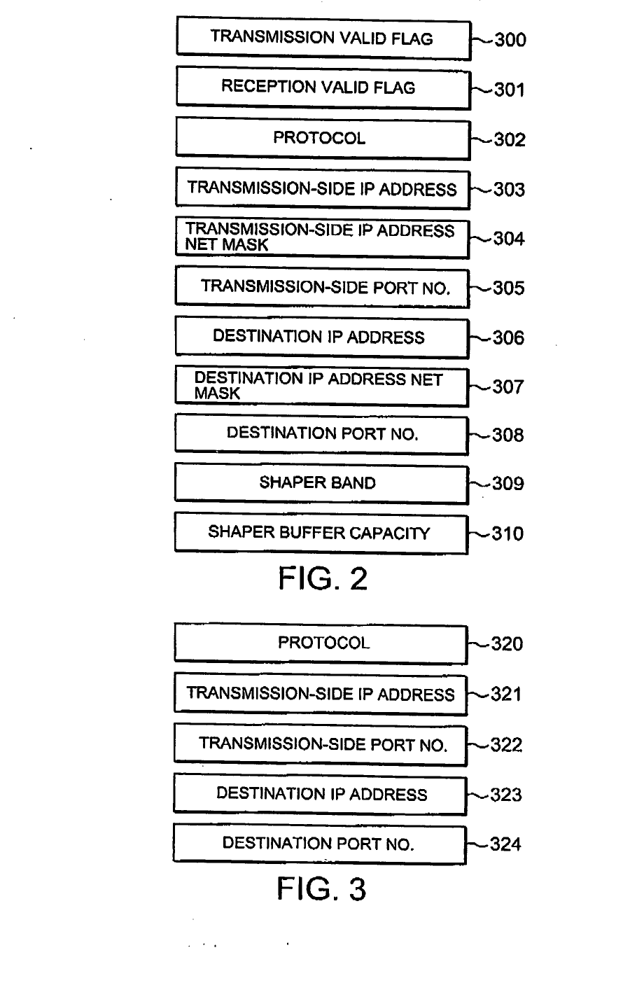

The initial setting data 111 has the structure shown in FIG. 2. Further, the initial setting data 111 contains a transmission valid flag 300, a reception valid flag 301, a protocol 302, a transmission-side IP address 303, a transmission-side IP address net mask 304, a transmission-side port number 305, a destination IP address 306, a destination IP address net mask 307, a destination port number 308, a shaper band 309, and a shaper buffer capacity 310. The initial setting data 111 is preset. Upon turning-on or resetting the network interface apparatus 200, the shaper-function management program 102 stores the initial setting data 111 to a setting-data storing unit 211 via the control program 103 and the management function unit 201. The transmission valid flag 300 designates whether or not the shaping of the flow on the transmission side is performed. The reception valid flag 301 designates whether or not the shaping of the flow on the reception side is performed. The protocol 302 indicates the type of the protocol used for the flow. Specifically, the protocol 302 indicates a TCP Transmission Control protocol) and a UDP (User Diagram Protocol). The transmission-side IP address 303 indicates an IP address on the transmission side of the flow. The transmission-side IP address net mask 304 indicates a net mask of the transmission side of the flow. The transmission-side port number 305 indicates a port number of the transmission side of the flow. The destination IP address 306 indicates an IP address on the flow destination. The destination IP address net mask 307 indicates a net mask on the flow destination. The destination port number 308 indicates a port number on the flow destination. The shaper band 309 indicates a band allocated to the shaping of the flow. The shaper buffer capacity 310 indicates the capacity of a shaper buffer allocated to the flow.

Similarly to the initial setting data 111, the dynamic setting data 112 has the structure as shown in FIG. 2. The dynamic setting data 112 is registered, and is changed and/or is deleted on the shaper-function management program 102 in response to the request from the application program 101.

In the setting information, the protocol, the transmission-side IP address, the transmission-side IP address net mask, the transmission-side port number, the destination IP address, the destination IP address net mask, and the destination port number are referred to as the flow identification information. The flow identification information has the structure shown in FIG. 3, and contains a protocol 320, a transmission-side address 321, a transmission-side port number 322, a destination IP address 323, and, a destination port number 324. Further, the remaining setting information, i.e., the transmission valid flag, the reception valid flag, the shaper band, and the shaper buffer capacity are referred to as the shaping setting information.

In the initial setting data 111 and the dynamic setting data 112, items of the flow identification information may designate not only a specific value but a value range. With respect to the net mask, AND operations of bits on the net masks for two comparing IP addresses are calculated, and the calculation results are compared, thereby determining the matching or non-matching. With the protocol and the port number, they are values other than 0 and, in this case, they match only the values. When the protocol and the port number are 0, they match all values and are registered. Therefore, upon registering the IP address, the net mask, the protocol, and the port as 0, all the values match each other.

When the flow identification information shown in FIG. 3 matches two pieces of registering data indicating one range, the priority is given to a narrow range. The narrow range has a large number of bits of 1 on the net mask of the IP address. On the same net mask, the narrow range is the net mask on which the protocol matches a value other than 0. On the net mask having the same protocol, the narrow range is the net mask on which the port matches a value other than 0.

The network interface apparatus 200 comprises the management function unit 201, the shaper function unit 202, the network interface function unit 203, the setting-data storing unit 211, and a flow-registering-data storing unit 212.

The management function unit 201 receives and transmits control information from/to the shaper-function management program 102 via the control program 103, and controls the operation of the shaper function unit 202 and the network interface function unit 203.

The shaper function unit 202 is on a data transfer interface between the control program 103 and the network interface function unit 203. Further, the shaper function unit 202 performs the shaping of a specific flow set as a shaping target. That is, the shaper function unit 202 adjusts a transfer velocity (transfer interval of packets) in accordance with the band set to the flow.

The network interface function unit 203 corresponds to a conventional network interface apparatus.

The setting-data storing unit 211 is a memory unit that stores data with the structure shown in FIG. 2, similarly to the initial setting data 111 and the dynamic setting data 112. The shaper function unit 202 performs the shaping of the flow specified by the flow identification information set to the setting-data storing unit 211 in accordance with the shaping setting information.

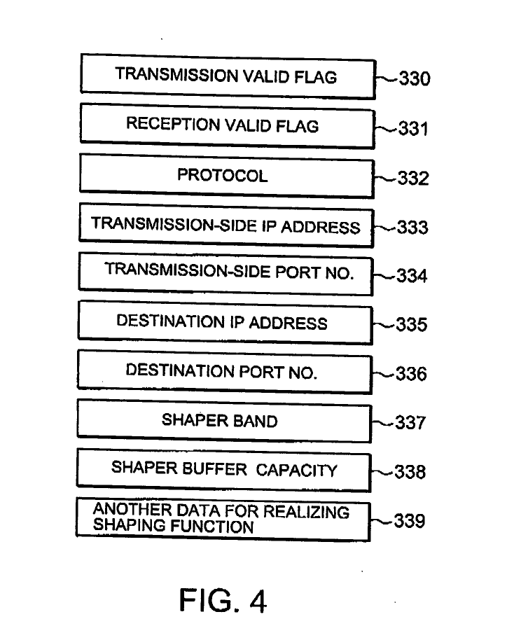

The flow-registering-data storing unit 212 is a memory unit that stores flow management data having the structure shown in FIG. 4. The flow management data stores the flow identification information on all flows via the shaper function unit 202. In addition, the flow management data stores the shaping setting information and another data 329 for realizing the shaping function if necessary. That is, the flow-registering-data storing unit 212 contains areas for storing a transmission valid flag 330, a reception valid flag 331, a protocol 332, a transmission-side address 333, a transmission-side port number 334, a destination IP address 335, a destination port number 336, a shaper band 337, a shaper buffer capacity 338, and another data 339 for realizing the shaping function. Unlike the initial setting data 111 and the dynamic setting data 112, the flow Identification information in the flow management data has a specific value, and does not have a value range. The content of the other data 339 for realizing the shaping function is varied depending on a shaping system mounted on the shaper function unit 202. However, the content of the other data 339 is not described in detail because it is not necessary in the operation according to the present invention, and a detailed description thereof is omitted.

The control program 103 is physically connected to the network interface apparatus 200 by a bus. The control program 103 is connected to the management function unit 201 via a control interface 150. The management function unit 201 is connected to the shaper function unit 202 via a control interface 252. The management function unit 201 is connected to the network interface function unit 203 via a control interface 253. In view of logical data transfer interfaces, the control program 103 is connected to the shaper function unit 202 via a data transfer interface 151. The shaper function unit 202 is connected to the network interface function unit 203 via a data transfer interface 254. Further, the network interface function unit 203 is connected to an external network via an external interface 260.

Hereinbelow, a description is given of the operation of the data communication apparatus 1.

(1) Initial Setting

First, the initial setting is executed as follows. A control program 104 initially sets the hardware level of the network interface apparatus 200. Subsequently, the control program 104 initially sets the network interface function unit 203 via a control interface 250, the management function unit 201, and the control interface 253. Subsequently, the control program 104 sends the notification indicating the end of the initial setting of the shaper-function management program 102. In accordance with the notification, the shaper-function management program 102 transmits content of the initial setting data 111 to the management function unit 201 via the control interface 250. Further, in accordance with the operation, the management function unit 201 stores the received data to the setting-data storing unit 211 and transmits a notification indicating that the setting information is updated to the shaper function unit 202. The shaper function unit 202 accesses the setting-data storing unit 211, and updates the flow management data stored in the flow-management-data storing unit 212 if necessary. The setting information is set, in the initial setting, to a flow whose frequent establishment or continuous establishment in the data communication apparatus 1 is know in advance.

(2) Shaper Control

After the initial setting operation, the operation of the shaper is controlled as follows. The shaper function unit 202 identifies the flow by referring to the flow identification information of the flow passing through the shaper function unit 202 via the data transfer interfaces 151 and 254. That is, the shaper function unit 202 obtains the flow identification information from content of an IP header in the IP packet, a TCP header, or a UDP header, and identifies the flow. After the initial setting, the shaper function unit 202 compares the flow identification information in the flow during the passage with the flow identification information in the setting information registered in the flow-management-data storing unit 212.

As a comparison result, upon registering the setting information on the flow to the flow-management-data storing unit 212 with a valid-flag (the transmission valid flag on the transmission side of the data communication apparatus 1 and the reception valid flag on the destination of the data communication apparatus 1) ON, the shaper function unit 202 performs the shaping of the flow in accordance with the shaping setting information corresponding to the flow identification information, and outputs the flow.

On the other hand, upon registering the setting information of the flow to the flow-management-data storing unit 211 with a valid-flag OFF, alternatively, without registering the setting information on the flow, the shaper function unit 202 further accesses the setting-data storing unit 211, and determines whether or not the setting information of the flow is registered. As mentioned above, the initial setting data 111 and the dynamic setting data 112 can designate the value range. Therefore, herein, the determination of the shaper function unit 202 is not limited to the simple matching of two values but may include the determination as whether the flow is included in the designated range.

Upon registering the flow or the range including the flow to the setting-data storing unit 211, the shaping of the flow, as a target, is performed in accordance with the corresponding shaping setting information, and the flow is output. In addition, the setting information on the flow is registered to the flow-management-data storing unit 212. When the flow matches the setting information of the range designation, the setting information having the flow, as a target, is extracted from the setting information, and is registered to the flow-management-data storing unit 212.

Without registering the corresponding flow to the flow-management-data storing unit 212 and the setting-data storing unit 211, the shaper function unit 202 transfers the flow by best effort. With the transmission valid-flag OFF and the reception valid-flag OFF, the setting information of the flow is registered to the flow-management-data storing unit 212.

As mentioned above, the shaper function unit 202 performs the shaping of the flow by referring to the shaping setting information varied depending on the flow.

(3) Update Setting Information The shaper-function management program 102 dynamically updates the setting information in response to a request from the application program 101. The setting information is updated when the application program 101 adds a new flow, when the application program 101 changes the flow characteristic, and when the application program 101 deletes the existing flow. Hereinbelow, a description is given of the operation for updating the setting information in the data communication apparatus 1.

First, the application program 101 requests the updating of the setting information to the shaper-function management program 102.

When the addition of the flow is requested, the shaper-function management program 102 adds new setting information to the dynamic setting data 112. Further, the shaper-function management program 102 instructs the operation for adding the setting information to the management function unit 201 via the control program 103 and the control interface 150. In response to the instruction, the management function unit 201 adds the setting information of a new flow to the setting-data storing unit 211, and sends a notification indicating the fact to the shaper function unit 202 via the control interface 252. In response to the notification, the shaper function unit 202 updates the data in the flow-management-data storing unit 212.

When the updating of the flow characteristic is requested, the shaper-function management program 102 adds the setting information including the shaping setting information indicating the changed flow characteristic to the dynamic setting data 112, and instructs the change of the shaping setting information on the flow in the setting-data storing unit 211 to the management function unit 201 via the control program 103 and the control interface 150. In accordance with the instruction, the management function unit 201 changes the shaping setting information on the flow in the setting-data storing unit 211, the management function unit 201 transmits a notification indicating this fact to the shaper function unit 202 via the control interface 252. In response to the notification, the shaper function unit 202 updates the data in the flow-management-data storing unit 212. Thus, the shaper band and the capacity of shaper buffer of the flow are changed. The application program 101 requests the change of the flow characteristic, when the amount of data to be transmitted is temporarily is increased and the shaper band is increased in accordance with the increase in the amount of data and when the above-increased shaper band is reset to the original band.

When the deletion of the flow characteristic is requested, the shaper-function management program 102 deletes the setting information of the flow to be deleted from the initial setting data 111 or the dynamic setting data 112, and instructs the deletion of the setting information of the flow in the setting-data storing unit 211 to the management function unit 201 via the control program 103 and the control interface 150. In accordance with the instruction, the management function unit 201 deletes the setting information of the flow in the setting-data storing unit 211, and transmits a notification indicating the fact to the shaper function unit 202 via the control interface 252. In accordance with the notification, the shaper function unit 202 updates the data of the flow-management-data management-data storing unit 212.

The setting information is updated as mentioned above, thereby designating the shaping on the unit basis of the flow and changing the shaping band and the capacity of shaper buffer on the unit basis of the flow on the application program 101 if necessary.

(4) Update Flow-Management-Data Storing Unit 212

As described in (3) above, in addition to the instructed deletion of the setting information of the flow from the flow-management-data storing unit 212 in the deletion of the flow, the shaper function unit 202 deletes the setting information of the flow whose packet is not received nor is transmitted for a predetermined period.

2. Second Embodiment

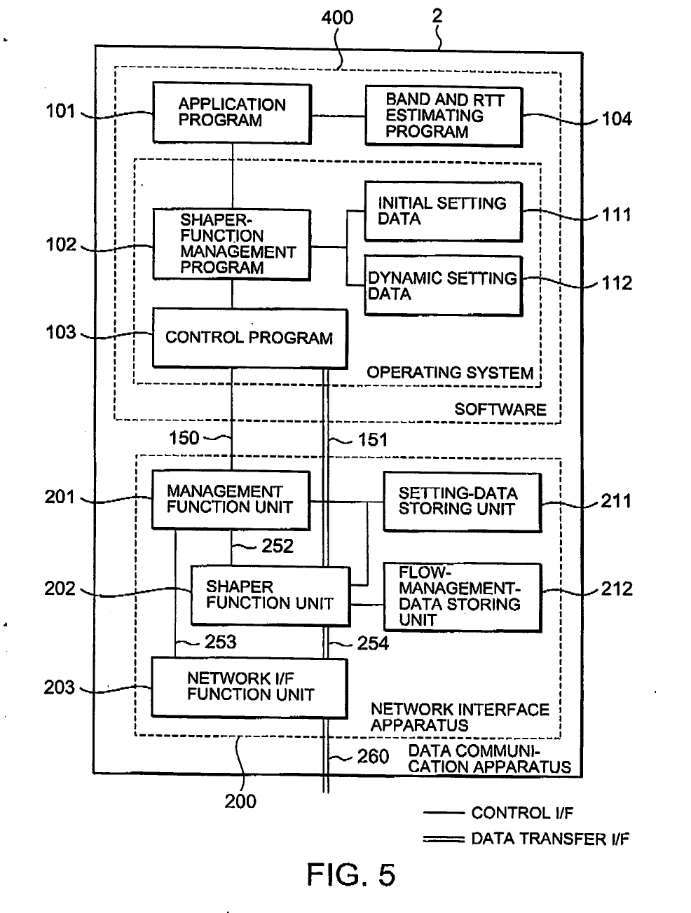

Hereinbelow, a description is given of the data communication apparatus 2 according to the second embodiment of the present invention with reference to FIG. 5. The basic operation according to the second embodiment is the same as that based on the first embodiment. However, unlike the first embodiment, software 400 includes a band and RTT (Round Trip Time) estimating program 104.

The band and RTT estimating program 104 enables a processor (not shown) of the data communication apparatus 2 to execute processing for estimating the network status, and estimates the network status by the band estimation and RTT estimation.

In the band estimating processing, a network-available band is estimated. For example, in packet-pair-type band estimation, four data packets on the TCP protocol are transmitted once. Upon receiving continuous packets, the reception side returns one ACK packet every two data-packets. Therefore, two ACK packets are returned for four data packets. The difference in arriving time of two ACK packets is assumed to keep the time delay for arrival of the two data-packets to the partner. Further, the difference between the sequence numbers for confirming the two ACK packets is equal to the amount of data of the two data-packets. Therefore, reference symbol B denotes an available band, reference symbol D denotes the difference between the sequence numbers for confirming the two ACK packets, and reference symbol T denotes the arrival-time interval of the two ACK packets. Then, the available band B is obtained by the following Expression 1.
B=D/T (Expression 1)

In the RTT estimating processing, a round trip time (RTT) is estimated. For example, upon transmitting the data packet, the sequence number and the transmitting time are stored in the memory. After receiving the ACK packet for confirming the transmission of the stored the sequence numbers, the RTT is estimated by obtaining the difference between the reception time and the transmission time. Further, the time stamp option of the TCP may be used.

The band and RTT estimating program 104 transmits a notification indicating the estimating result to the application program 101. In accordance with the notification, the application program 101 requests the change of the flow characteristic to the shaper-function management program 102. The operation of the shaper-function management program 102 in response to the request is the same as that in “(3) Update setting information”.

The band and RTT estimating program 104 may be mounted as a part of the functions of the OS. Alternatively, the band and RTT estimating program 104 may be provided as a part of the application program 101.

According to the second embodiment, the setting of the shaping on the unit basis of flow can be dynamically changed in accordance with the change of the network status.

3. Third Embodiment

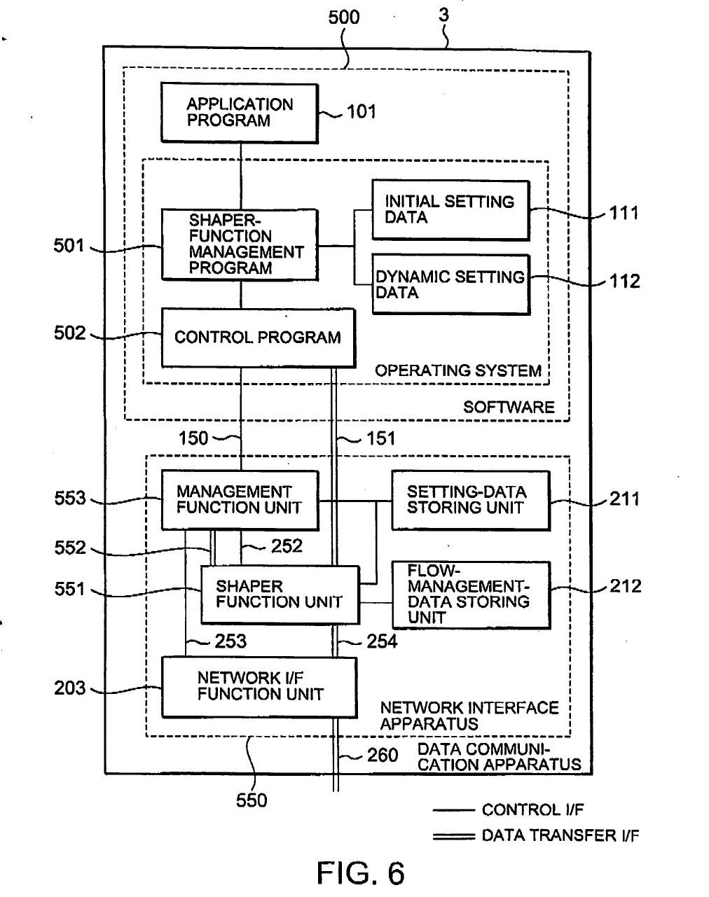

Hereinbelow, a description is given of the data communication apparatus 3 according to the third embodiment of the present invention with reference to FIG. 6. The basic operation according to the third embodiment is the same as that according to the first embodiment. In the data communication apparatus 1, the control information is transmitted from the shaper-function management program 102 to the shaper function unit 202 via the control program 103, the control interface 150, the management function unit 201, and the control interface 252. However, as compared with the case according to the first embodiment, in the data communication apparatus 3 according to the third embodiment, a shaper-function management program 501 transmits control information via the control program 103, the data transfer interface 151 and 552, a management function unit 553, and the control interface 252.

Similarly to the shaper-function management program 102, the shaper-function management program 501 reads and writes the initial setting data 111 and the dynamic setting data 112, and generates the control information on a shaper function unit 551. The generated control information is formed and is output as a UDP packet. The UDP packet is transferred via the data transfer interface 151 to the shaper function unit 551. The shaper function unit 551 monitors the packet received from the control program 103 and detects the UDP packet that stores the control information and, in this case, transfers the UDP packet to the management function unit 553 via the data transfer interface 552. The management function unit 553 extracts the control information from the UDP packet, and sends a notification indicating the control information via the control interface 252 to the shaper function unit 551. Alternatively, the management function unit 553 updates the setting information in the setting data storing unit 111.

According to the third embodiment, it is possible to use, as a control program 502, a driver program for controlling only the operation of the network interface function unit 203.

4. Fourth Embodiment

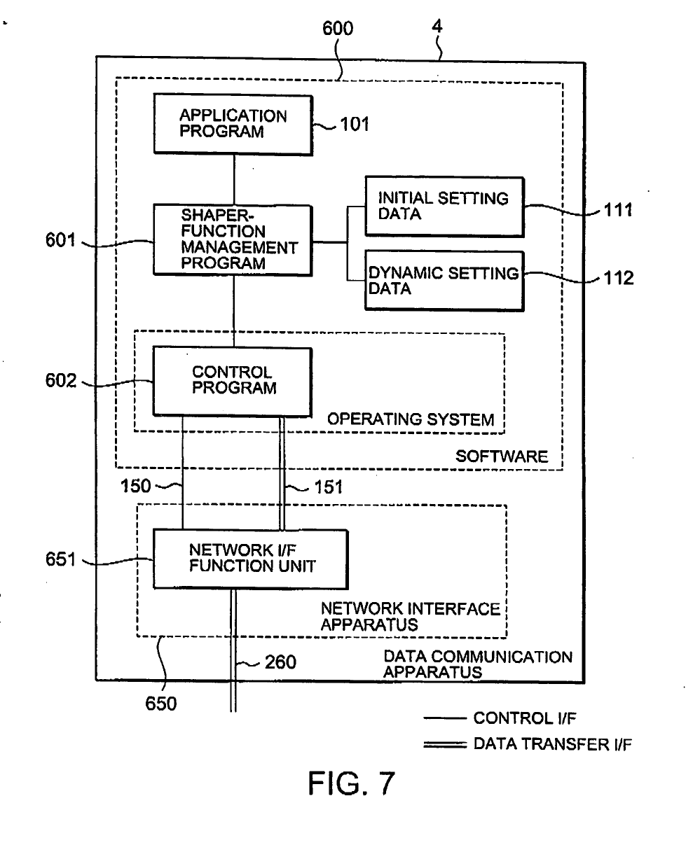

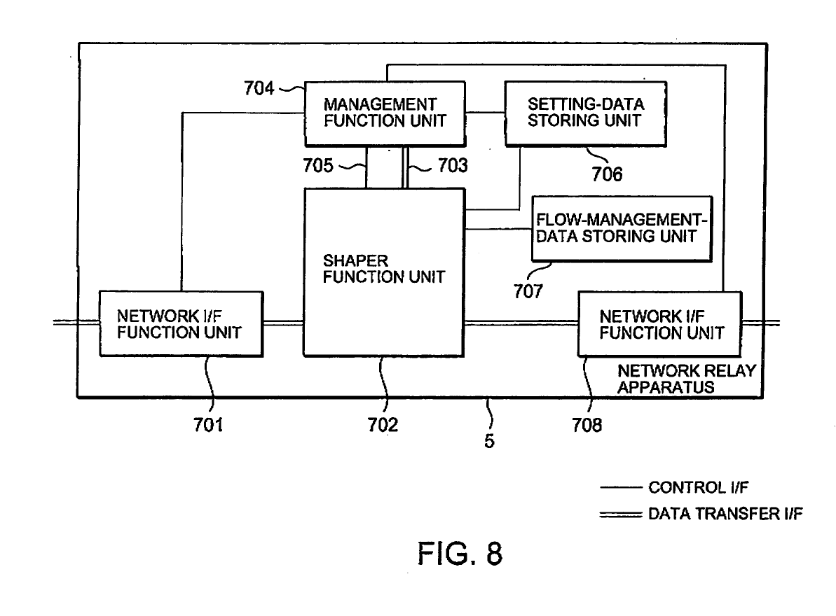

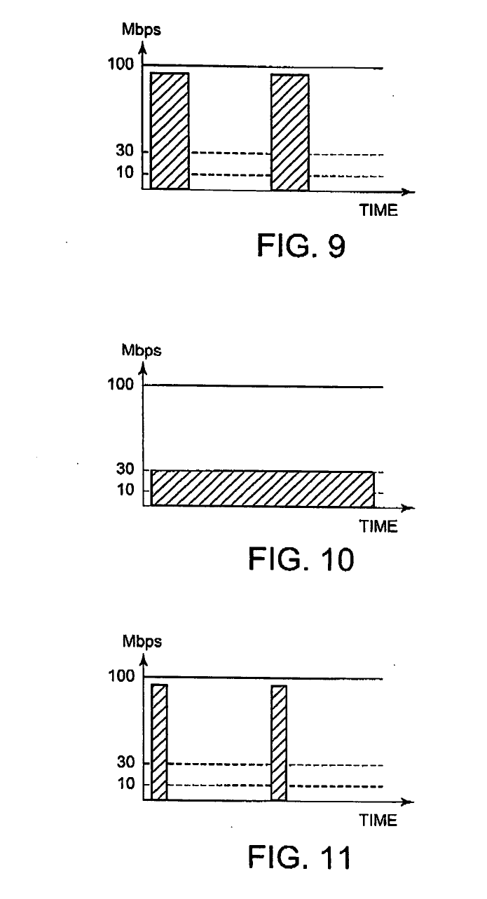

Hereinbelow, a description is given of a data communication system according to the fourth embodiment of the present invention. The data communication system according to the fourth embodiment comprises a data communication system 4 shown in FIG. 7 and a network relay apparatus 5 shown in FIG. 8, as an external device, which is connected to the data communication system 4 via a data transfer interface, such as a LAN cable. The basic operation according to the fourth embodiment is the same as that according to the first embodiment.

Similarly to the shaper-function management program 501, a shaper-function management program 601 reads and writes the initial setting data 111 and the dynamic setting data 112, and generates the control information of the shaper function unit 551. Further, the shaper-function management program 610 outputs the generated control information as a UDP packet.

A network interface function unit 651 transmits the UDP packet, similarly to another general UDP packet, from a data transfer interface 260.

The UDP packet including the control information, transmitted from the data communication apparatus 4, is transmitted to a shaper function unit 702 via a network interface function unit 701. The shaper function unit 702 monitors the packet received from the network interface function unit 701 and detects a shaper function unit 702 that stores the control information and, in this case transfers the control information to a management function unit 704 via a data transfer interface 703. The management function unit 704 extracts the control information from the UDP packet, and transmits a notification indicating the control information to the shaper function unit 702 via a control interface 705. Alternatively, the setting information in a setting-data storing unit 706 is updated.

According to the fourth embodiment, it is possible to use, as a control program 602, a driver program that controls only the operation of the network interface function unit 651.

Further, it is possible to use a conventional and general network interface apparatus without the functional blocks including the management function unit, the setting-data storing unit, the flow-management-data storing unit, and the shaper function unit.

5. Advantages

The flow output from the application program 101 is influenced from a scheduler of the 0 and the reading processing from a disk, and is intermittently transmitted to the network interface apparatus 200. It is assumed that the network interface apparatus 200 intermittently receives data with a band of 100 Mbps or less.

The shaper function unit 202 performs the shaping of the flow on the basis of the setting data stored in the setting-data storing unit 211. When the band set to the flow is 30 Mbps, referring to FIG. 10, the flow is smoothed to a constant band of 30 Mbps.

During establishing the flow, the application program 101 changes the flow characteristic in the band reducing direction. Alternatively, the band and RTT estimating program 104 determines the reduction of an available band of the flow. In this case, similarly, the data is intermittently output from the software 100 to the network interface apparatus. However, the connecting time per one-time data transmission is reduced as shown in FIG. 11.

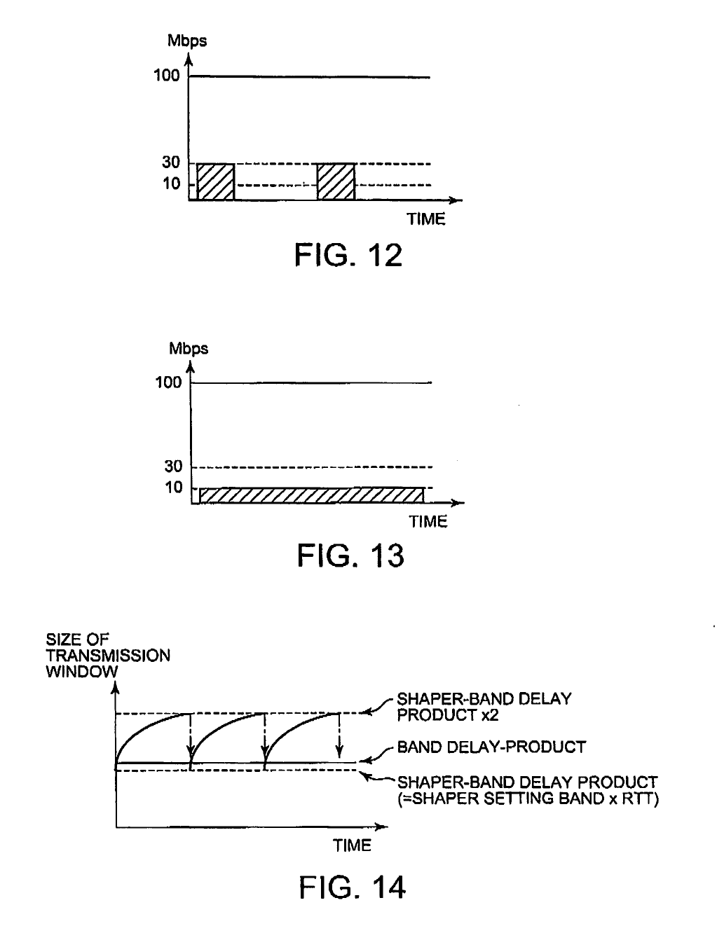

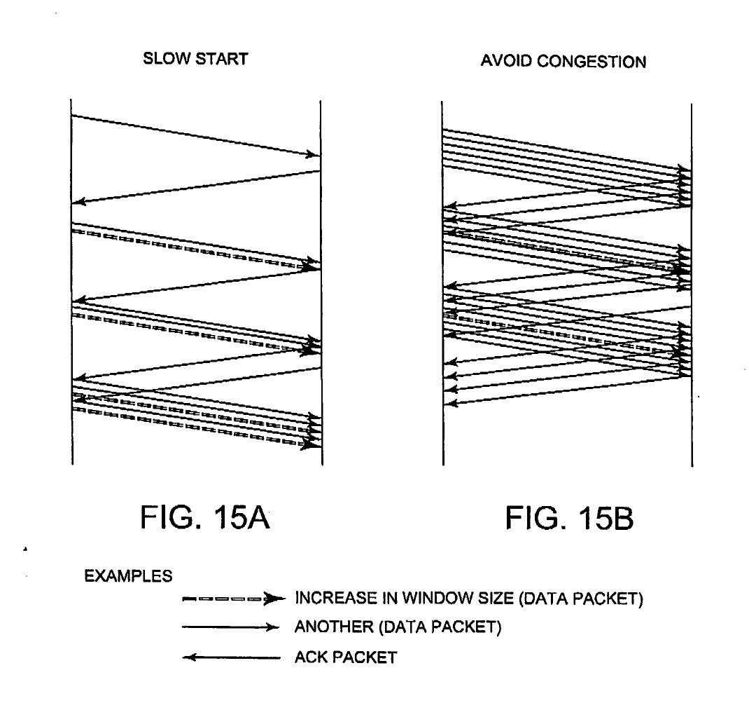

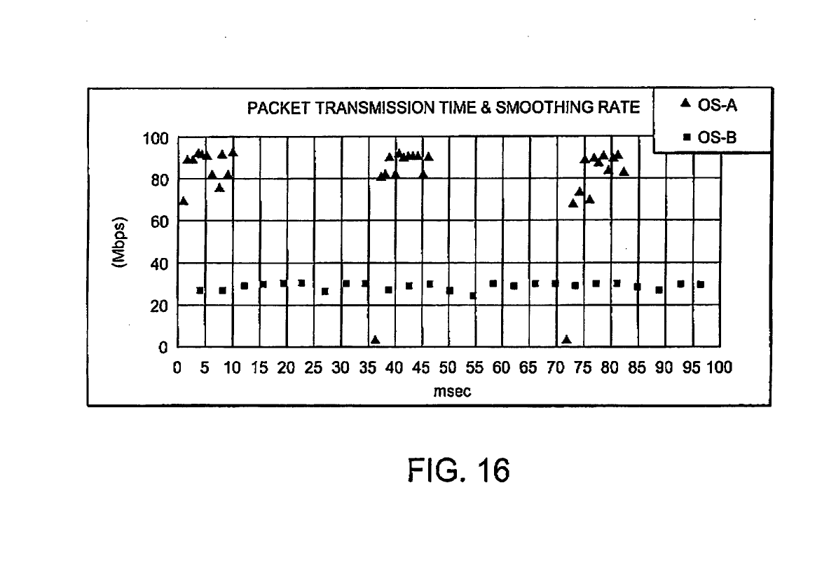

Upon continuously performing the shaping on the basis of the setting data, referring to FIG. 12, the maximum band is reduced to 30 Mbps. Therefore, even in this status, as compared with the output case in the status shown in FIG. 11, the possibility of the packet abandonment is reduced, corresponding to the reduction of the maximum band. However, the time zone without transmission remains and, therefore, the packet is smoothed so as to transmit the packet even during the time zone, thereby further suppressing the possibility of the abandonment of the packet.

Then, according to the present invention, the application program 101 sends a notification indicating the fact to the shaper-function management program 102, upon changing the flow characteristic of the flow to be transmitted or upon changing the available band of the network. In response to this, the shaper-function management program 102 updates the dynamic setting data 112, further updates the setting data in the setting-data storing unit 211, and transmits a notification indicating the updating to the shaper function unit 202. In accordance with the operation, the shaper function unit 202 smoothes the packet by narrowing the band. Thus, it is possible to output the data within an equal band without intermission, as shown in FIG. 13.

FIG. 14 shows an example in which the data is efficiently transferred by attaching a network interface apparatus with a packet shaper to a server for transferring a large amount of data on the TCP protocol. The server is connected to a client via a route that ensures the band by a network service provider.

The shaper band is set to a value obtained by multiplying the ensured band by α (α<1, e.g., α=0.9). Further, the shaper buffer capacity is set to a product (hereinafter, referred to as a shaper-band delay product) of the set shaper band and the reciprocating delay time RTT between the server and the client.

With the above setting, the bottle neck, that is, the smallest band between the server and the client operates as a shaper function of the server. In TCP Reno, serving as a version that is widely used as a TCP program, the size of transmission window is increased by one data packet every reciprocating delay time upon stably transferring the data packet, and the size of transmission window is reduced to the half when the size of transmission window is excessively large and the packet is abandoned.

Since the bottle neck operates as the shaper function unit, the size of transmission window is over the delay product of the shaper band and, in this case, the transmission rate from the TCP program is over the shaper band and remains in the buffer of the shaper. The amount of remaining data is expressed as [(the size of transmission window)−(the shaper-band delay product)]. When the size of transmission window is equal to the twice of the shaper-band product, the amount of data in the packet remaining in the buffer of the shaper is equal to the amount of buffer of the shaper. Therefore, the shaper function unit abandons the packet. When the TCP program reduces the size of transmission window to the half, the obtained value becomes the shaper-band delay product.

In order to repeat the above time transition, the size of transmission window always keeps a value that is the shaper-band delay product or more. The transmission rate from the shaper is a smaller value of the setting band of the shaper and (the reciprocating delay time from the size of transmission window to the reciprocating delay time between the server and the client). However, since the size of transmission window always keeps a value that is the shaper-band delay product or more, the transmission rate always becomes the setting band of the shaper, that is, a value obtained by multiplying the ensuring band by α. Thus, the data is stably and efficiently transferred.

Without using the shaper, a node in the via-network becomes the bottle neck. If the buffer capacity of a transmission-standby buffer of the node is sufficient, the same advantages are obtained. However, the buffer capacity of the node in the network is not generally ensured. The bottle neck is set to a portion controlled by a user with the shaper and the user properly sets the buffer capacity of the portion, thereby efficiently transferring the data without fail.

The above description is based on the embodiments of the present invention. However, the present invention is not limited to this and, obviously, can be changed or be modified within the general knowledge of those skilled in the art.

For example, it is obvious for those skilled in the art that the band and RTT estimating program 104 according to the second embodiment can be embodied by the combination with another embodiment.

Further, it is obvious for those skilled in the art that the band and RTT estimating program may be incorporated as a part of the application program.

What is claimed is:

1. A method of controlling a shaper for traffic shaping to flows of data communication between first and second data communication apparatuses, the method comprising:
a step of identifying a flow by the first data communication apparatus;
a step of designating, by the first data communication apparatus, whether or not the shaping to the identified flow is performed; and
a step of performing the shaping on the unit basis of a flow by the shaper in accordance with the designation.

2. The method claimed in claim 1, wherein the first data communication apparatus designates shaping setting information on the unit basis of a flow, the shaping setting information being setting information for traffic shaping by the shaper.

3. The shaper control method claimed in claim 2, wherein the shaping setting information on a flow is updated in accordance with condition of the flow.

4. The shaper control method claimed in claim 1, wherein best-effort-type communication is provided for a flow to which performance of the shaping is not designated at the designating step.

5. A data communication system comprising:
a circuit for designating, on the unit basis of a flow, whether or not the shaping of a flow between one data communication apparatus and another data communication apparatus is performed; and
a shaper for performing the shaping on the unit basis of the flow in accordance with the designation.

6. The data communication system claimed in claim 5, further comprising a circuit for designating, on the unit basis of a flow, shaping setting information, serving as setting information on the shaping, and
the shaper performs the shaping in accordance with the shaping setting information.

7. The data communication system claimed in claim 6,
further comprising a circuit for estimating the condition of the flow,
wherein the shaping setting information of the flow is updated in accordance with the estimation result.

8. The data communication system claimed in claim 5, wherein best-effort-type communication is provided for the flow to which the shaping is not designated by the circuit for designating whether or not the shaping is performed.

9. A network interface apparatus for providing a network interface for a computer by being connected to the computer via a control interface and a data transfer interface of the computer, comprising a shaper for performing shaping on the unit basis of a flow.

10. The network interface apparatus claimed in claim 9, wherein the shaper performs shaping of a flow designated by the computer or by another computer establishing the flow with the computer for data communication.

11. The network interface apparatus claimed in claim 9, wherein shaping of the shaper is set in accordance with the setting information that is generated by the computer or by another computer establishing the flow with the computer for data communication.

12. The network interface apparatus claimed in claim 9, wherein the setting of the shaper is updated in accordance with condition of the flow received by the computer or by another computer establishing the flow with the computer for data communication.

13. The network interface apparatus claimed in claim 9, further comprising:
a circuit for extracting control information of the shaper from a packet which stores control information of the network interface apparatus.

14. The network interface apparatus claimed in claim 10, providing best-effort-type communication to a flow without the designation.

15. A network relay apparatus comprising a shaper for shaping on the unit basis of a flow through the network relay apparatus,
wherein the shaper performs shaping of a flow in response to a request from a data communication apparatus establishing the flow.

16. The network relay apparatus claimed in claim 15, wherein the shaping is set in accordance with setting information generated by the data communication apparatus.

17. The network relay apparatus claimed in claim 15, wherein the shaping is set in accordance with the condition of the flow obtained by the data communication apparatus.

18. A computer program product for a computer system performing data communication with a data communication apparatus by establishing a flow with the data communication apparatus, a shaper performing shaping of the flow,
wherein the computer program product comprises one or more computer-readable media having computer-executable instructions for performing the steps of:
generating flow identification for identifying a flow;
generating a flag for designating whether or not the shaper performs shaping of the flow; and
outputting the flow identification information and the flag so that the shaper performs the shaping in accordance with the flow identification information and the flag.

19. The computer program product claimed in claim 18, the media further having computer-executable instructions for performing the steps of generating shaping setting information, serving as setting information on the shaping of the flow, 20. The computer program product claimed in claim 19, the media further having computer-executable instructions for performing the steps of:
estimating the communication of the flow; and
generating the shaping setting information in accordance with the estimating result.
